(19) United States
(12) Patent Application Publication
(10) Pub. No.: US 2006/0096620 A1
(43) Pub. Date: May 11, 2006

(54) Behind-sink dishwasher

(75) Inventors: Robert M. Byrne, Lima, OH (US); Kurt F. Hafeken SR., Elida, OH (US)

Correspondence Address: RANKIN, HILL, PORTER & CLARK, LLP, 925 EUCLID AVENUE, SUITE 700, CLEVELAND, OH, 44115-1405, US

(73) Assignee: American Trim, LLC, Lima, OH (US)

(21) Appl. No.: 10/985,337

(22) Filed: Nov. 10, 2004

(51) Int. Cl. B08B 3/00; B08B 3/12

(52) U.S. Cl. 134/56 D; 134/58 D; 134/172

(57) ABSTRACT

A dishwasher assembly is disclosed including one or more racks for retaining one or more dishware items to be washed. A washer system is provided for respectively washing and drying the dishware item. A dishwasher housing is used for retaining the rack and the washer system. The dishwasher housing includes a door for accessing the rack, to enable the inserting and removing the dishware item. Preferably, the rack is a rotary rack that cooperates with a rotation assembly for rotating the rack. Also, the dishwasher housing preferably includes a first wall-facing side and a second wall-facing side. The first and second wall-facing sides are preferably formed at a desired angle, so as to fit into a corner.

### BACKGROUND OF THE INVENTION

The presently disclosed embodiments are directed to the field of dishwashers, particularly home dishwashers of the type designed for efficient space utilization. Dishwashers have long been used in the home for cleaning dishware items. Such home dishwashers are typically of a conventional type, such as a front-loading tub dishwasher or the like that fits under a kitchen countertop.

A conventional dishwasher must be loaded and unloaded with each wash cycle. It frequently happens that a dishwasher may not be unloaded after a wash cycle, so that clean dishes sit in the dishwasher for an extended period of time. This can create confusion among family members, since it may be uncertain whether a particular load is clean or unclean awaiting washing. Thus, it can happen that clean dishes and dirty dishes may become mixed up, creating a sanitation problem.

Since a conventional dishwasher sits under a countertop, most users need to stoop over to load and unload the dishwasher. This can be difficult for users with back problems or other physical limitations. Also, it can be difficult for users to load and unload dishes at the back of the dishwasher, since the racks and overall structure of the dishwasher can create obstacles. Thus, it is common for most dishes to be loaded toward the front. This can result in inefficient utilization of available rack space, since the dishwasher may not be fully loaded in the back during a wash cycle.

Recent trends in kitchen design are focusing on a variety of different consumer needs in the areas of food preparation and cleanup. A number of different dishwasher designs have been previously contemplated that meet various cleanup needs. It has thus been known to place a dishwasher assembly in drawers and in units within sink basins. It has also been known to make a portable countertop dishwasher. However, none of these designs are capable of addressing the various needs as indicated above.

### SUMMARY OF THE INVENTION

The difficulties and drawbacks associated with previous type systems are overcome by the present cupboard or behind-sink dishwasher assembly, including one or more racks for retaining one or more dishware items to be washed. A washer system is provided for respectively washing and drying the dishware item. A dishwasher housing is used for retaining the rack and the washer system. The dishwasher housing includes a door for accessing the rack, to enable the inserting and removing of the dishware item. Preferably, the rack is a rotary rack that cooperates with a rotation assembly for rotating the rack. Also, the dishwasher housing preferably includes a first wall-facing side and a second wall-facing side. The first and second wall-facing sides are preferably formed at a desired angle, so as to fit into a corner.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIGS. 1A, 1B and 1C generally depict alternative configurations of a dishwasher in accordance with the present embodiments.

FIG. 2 shows a peristaltic pump in accordance with a preferred embodiment.

FIGS. 3A, 3B and 3C are cutaway views showing alternative sprayer arrangements, in accordance with the present embodiments.

FIGS. 4A and 4B are side sectional views depicting the present soap dispenser, in accordance with a preferred embodiment.

### DETAILED DESCRIPTION OF THE INVENTION

The figures generally show a dishwasher assembly 10 in accordance with the present embodiments. A dishwasher housing 12 is provided for retaining the at least one rack 14 and a washer system 16. The rack 14 is provided for retaining one or more dishware items to be washed. The washer system 16 is provided for respectively washing and drying the dishware items. The dishwasher housing 12 includes a door 18 for accessing the rack 14, for inserting and removing one or more dishware items. In the preferred embodiment, the door 18 is a tambour sliding door that extends from one side to the other. However, the door 18 can also be two tambour doors that extend from each side and meet in the middle. It should also be appreciated that the door 18 can be any other suitable type of door, without departing from the present invention.

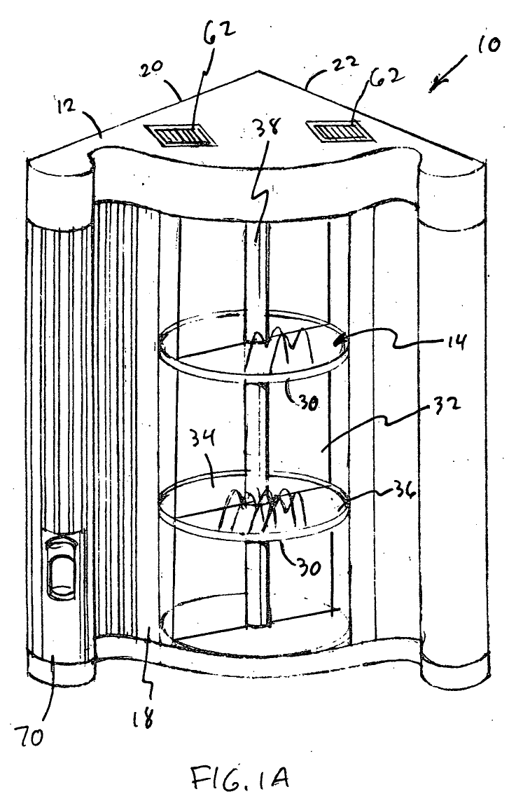

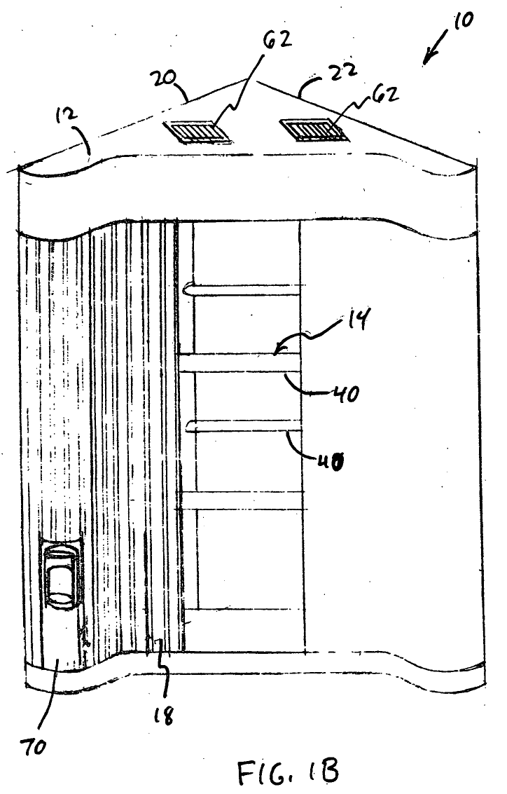

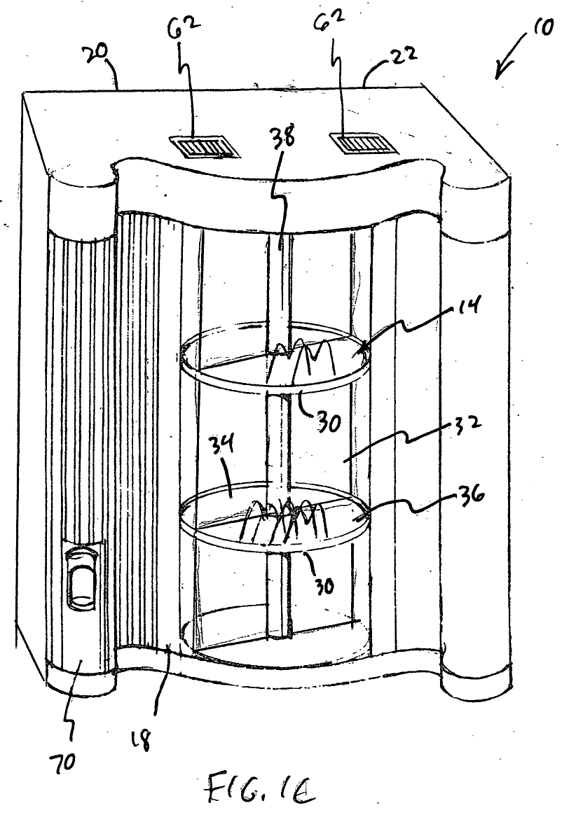

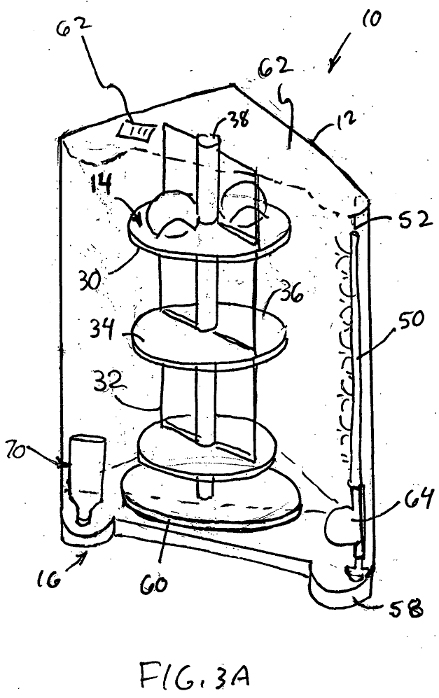

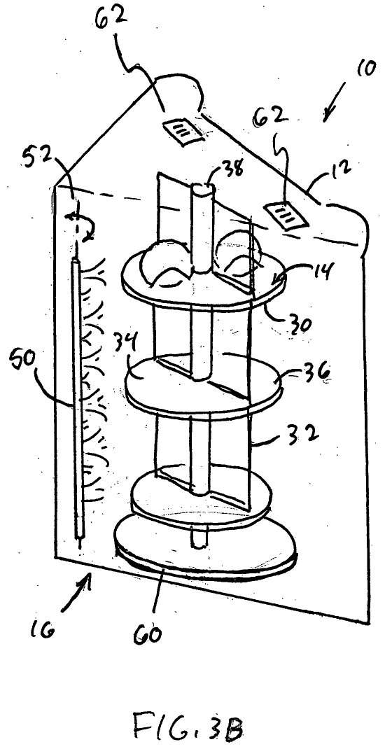

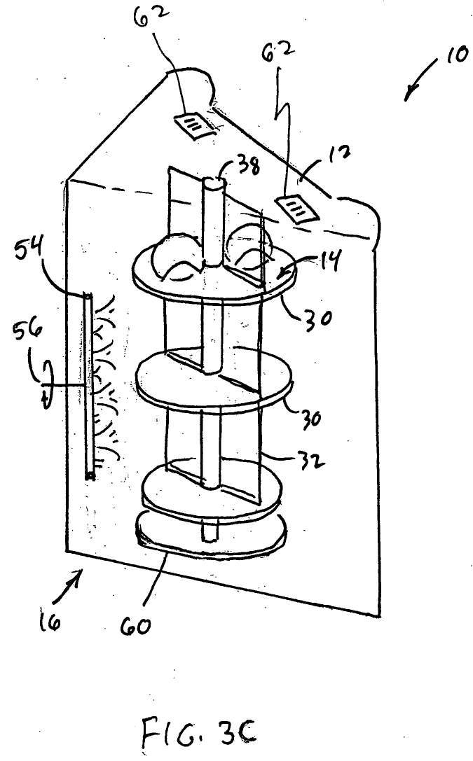

The present dishwasher housing 12 includes a first wall-facing side 20 and a second wall-facing side 22. The first and second wall-facing sides 20, 22 are respectively formed at a predetermined angle. In the preferred embodiment, as shown in FIGS. 1A, 1B, 3A and 3B, the first and second wall-facing sides 20, 22 are each formed at a predetermined angle of substantially ninety degrees with respect to each other, and less than ninety degrees with respect to the door, so as to fit into a square corner, e.g. along a corner wall area of a kitchen. In this embodiment, as is also shown in the above figures, the door 18 is formed so as to extend between the first and second wall-facing sides 20, 22, so as result in a dishwasher assembly having a substantially triangular cross-section for enclosing the rack and washer system.

In an alternative embodiment, as shown in FIG. 1C, the first and second wall-facing sides 20, 22 are formed at a predetermined angle of substantially zero degrees with respect to each other, so as to substantially define a single flat surface and thereby fit against a flat wall. In this alternate embodiment, the door 18 is formed so as to be substantially parallel to the first and second wall-facing sides 20, 22. This results in a dishwasher assembly 10 having a substantially rectangular cross-section for enclosing the rack and washer system.

In another aspect of the invention, as shown in FIGS. 1A, 1C, 3A, 3B, and 3C, the rack 14 of the present dishwasher assembly 10 includes one or more rotary racks 30. These rotary racks 30 preferably include a divider section 32 for dividing the rotary rack 30 into a first section 34 and a second section 36. A plurality of multi-tiered rotary racks 30 can be provided, and mounted along the divider section 32, so that a single divider section 32 can be used to divide all the multi-tiered rotary racks 30.

A rotation assembly 38 is provided for rotating the rotary rack 30 so as to alternately present either the first section 34 or the second section 36 to a first position, disposed proximate to the washer system, so as to enable the dishes in that first position to be washed. At the same time, the other one of the first and second sections 34, 36 is presented in a second position, disposed proximate to the door. At this position, the dishware item(s) can be inserted or removed from the dishwasher assembly 10.

At a later time, the rotation assembly 38 can be again rotated so as to allow the other of the first or second sections 34, 36 to be rotated to the first position, where dirty dishes can be washed. At the same time, the newly washed dishes from the other respective section 34, 36 can be rotated into the second position where they can be unloaded for use.

In another alternate embodiment, as is illustrated in FIG. 1B, the rack 14 includes a straight rack 40. It will be appreciated that a plurality of straight racks 40 can be retained within the dishwasher housing 12, so as to have a multi-tiered shelf arrangement. It will also be appreciated that the straight rack 40 can also be incorporated into the flat wall cabinet design as shown in FIG. 1C, all without departing from the present invention.

As is especially shown in FIGS. 3A, 3B and 3C, the present washer system 16 comprises a spray arm for spraying water and a heating arrangement for drying the dishware items. As shown in FIGS. 3A and 3B, the spray arm is preferably a linear spray arm 50 or rack having a linear axis 52 and configured for spraying with an oscillating motion about the linear axis 52. An alternative embodiment is shown in FIG. 3C, where the spray arm is a rotating spray arm 54, configured for rotation about a rotational axis 56.

In the embodiment of FIG. 3A, the spray arm 50 is mounted near the front of the housing 12, and the pump 62 is preferably connected thereto from directly below. However, the pump 62 can be advantageously located anywhere within the housing 12 and connected to the spray arm 50 using a tube or other suitable conduit. Alternatively, the spray arm 50 could be located in the back of the housing 12, as shown in FIGS. 3B and 3C. These embodiments allow the dishes to be washed on one side of the divider 32 to be positioned toward the back, disposed proximate to the washer system, while cleaned dishes on the other side of the divider 32 are disposed proximate to the door, so as to be inserted or removed from the dishwasher assembly 10.

The heating arrangement of the present washer system 16 also includes a flash dryer system, including a heater/blower arrangement 60 and one or more vents 62 for allowing the steam to quickly escape as soon as it is created. In this way, the dishes can be quickly dried with the present unit.

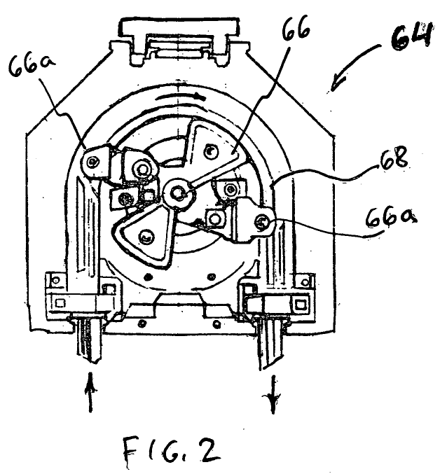

As shown especially in FIG. 2, the present washer system also includes a peristaltic pump 64 for pumping water onto the at least one dishware item. Water is fed to the pump 62 from a fixture located underneath the housing 12, as will be further discussed below. In the preferred embodiment, as shown in FIG. 3A, the pump 62 is connected to a water tank 58 configured to supply water for a dishwasher cycle. The pump 64 includes a rotor 66 having a plurality of nodes 66a. The nodes 66a make contact with a tube 68 for feeding water to the dishwasher assembly 10.

As the rotor 66 turns, the nodes 66a compress the tube 68, drawing up water into the pump 64 and driving a water flow out into the dishwasher assembly 10. As the nodes 66a turn, a pressure wave is introduced into the water flow, having a frequency corresponding the period of rotation of the rotor 66. This results in a pulsation of the water stream exiting the linear spray arm 50 at a frequency corresponding to the pressure wave, which assists in the cleaning action of the water stream. The water is preferably supplied at a temperature of about 140° F., so as to provide sterilization of the dishes.

Also, the spray arm 50 is configured to oscillate back and forth in a reciprocal motion corresponding to the frequency of the pressure wave, so as to spray water throughout the dishwasher assembly. In this way, the peristaltic pump 64 provides continuous water pumping and quiet operation, so that the present dishwasher assembly 10 has a low level of operating noise in a home kitchen environment.

The present dishwasher assembly 10 also includes a detergent dispenser 70 for retaining a cleaning agent. In the preferred embodiment, as shown in FIGS. 1A, 1B, and 1C, the detergent dispenser 70 is mounted in the front of the housing 12, to thereby enable easy filling of detergent by the end user. In the preferred embodiment, the detergent dispenser 70 is a bulk detergent dispenser for retaining and dispensing a quantity of cleaning agent sufficient for a plurality of wash cycles.

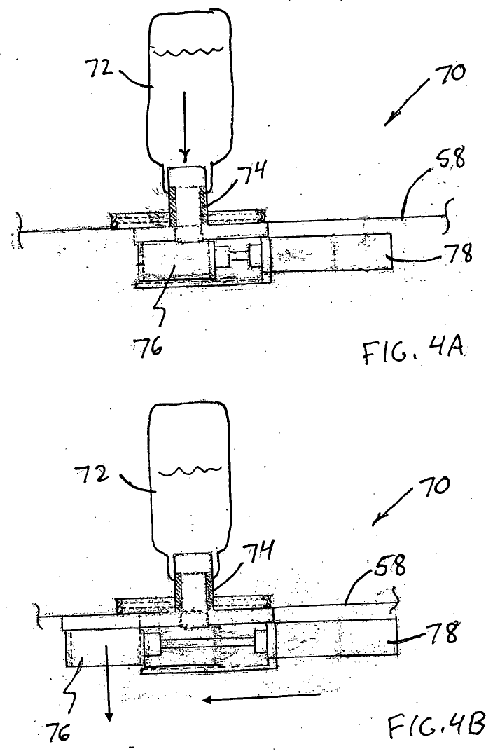

As is especially shown in FIGS. 4A and 4B, the detergent dispenser 70 is configured to receive a container 72 of detergent on a fitting 74. The container 72 can be a standard “off the shelf” container of detergent, or it can be a specially-designed bottle made and sold by the detergent manufacturer. Alternatively, the container 72 can be a refillable receptacle for receiving a quantity of detergent. The fitting 74 can be a simple “force-fit” neck for receiving the container 72. The fitting 74 can also include a threaded collar or a “quick connect” type connector, or any other suitable connecting member, as would be known in the art. The container 72 can also include a seal made of foil, plastic or other such frangible material. The fitting 74 can also include a puncturing member for piercing the seal upon insertion of the container 72 onto the fitting 74.

The dispenser 70 also includes a detergent collection cup 76. The detergent flows into the fitting 74 under the force of gravity, and into the collection cup 76. During a wash cycle, the collection cup 76 is emptied using a motor 78, which displaces the collection cup 76 from a “fill” position shown in FIG. 4A to an “empty” position shown in FIG. 4B, where the detergent flows into the water tank 58 under the force of gravity. In the preferred embodiment, the motor 78 is a wax motor, which includes a thermally-sensitive wax material that expands and contracts a piston in response to changes in temperature. A wax motor is advantageous for being inexpensive, efficient and reliable. However, it is appreciated that any suitable type of motor could be used, such as a solenoid motor or the like, without departing from the invention.

As described hereinabove, the present invention solves many problems associated with previous type devices. However, it will be appreciated that various changes in the details, materials and arrangements of parts which have been herein described and illustrated in order to explain the nature of the invention may be made by those skilled in the area within the principle and scope of the invention will be expressed in the appended claims.

We claim:

1. A dishwasher assembly comprising:
at least one rack for retaining at least one dishware item to be washed;
a washer system for respectively washing and drying the dishware item;
a dishwasher housing for retaining the at least one rack and the washer system comprising:
a first wall-facing side and a second wall-facing side, wherein the first and second wall-facing sides are respectively formed at a predetermined angle; and
a door for accessing the at least one rack, for inserting and removing the at least one dishware item.

2. The dishwasher assembly of claim 1 wherein the at least one rack comprises:
at least one rotary rack including a divider section for dividing the rotary rack into first and second sections;
a rotation assembly for rotating the rotary rack so as to alternately present a respective one of the first and second sections to a first position, disposed proximate to the washer system, and a respective other of the first and second sections to a second position, disposed proximate to the door for inserting and removing the at least one dishware item.

3. The dishwasher assembly of claim 2 wherein the at least one rotary rack comprises a plurality of multi-tiered rotary racks mounted along the divider section.

4. The dishwasher assembly of claim 1 wherein the at least one rack comprises at least one straight rack

5. The dishwasher assembly of claim 1 wherein the washer system comprises a spray arm for spraying water and a heating arrangement for drying the at least one dishware item.

6. The dishwasher assembly of claim 5 wherein the spray arm is a linear spray arm having a linear axis and configured for spraying with an oscillating motion about the linear axis.

7. The dishwasher assembly of claim 5 wherein the spray arm is a rotating spray arm.

8. The dishwasher assembly of claim 5 wherein the heating arrangement comprises a flash dryer system.

9. The dishwasher assembly of claim 1 wherein the washer system comprises a peristaltic pump for pumping water onto the at least one dishware item.

10. The dishwasher assembly of claim 9 wherein the washer system includes a linear spray rack and said peristaltic pump pulses said water.

11. The dishwasher assembly of claim 1 wherein the washer system comprises a detergent dispenser for retaining a cleaning agent.

12. The dishwasher assembly of claim 11 wherein the detergent dispenser is a bulk detergent dispenser for retaining and dispensing a plurality of wash cycles of cleaning agent.

13. The dishwasher assembly of claim 12 wherein the detergent dispenser is configured to receive a container of detergent on a fitting, wherein detergent flows from the container into the fitting under the force of gravity, and into a collection cup, which is emptied by a motor that displaces the collection cup from a “fill” position to an “empty” position where the detergent flows into the dishwasher assembly under the force of gravity.

14. The dishwasher assembly of claim 13 wherein the motor is a wax motor.

15. The dishwasher assembly of claim 1 wherein the door is formed so as to extend between the first and second wall-facing sides, and wherein the first and second wall-facing sides are formed at a predetermined angle of less than ninety degrees with respect to the door.

16. The dishwasher assembly of claim 15 wherein the first and second wall-facing sides are formed at a predetermined angle of substantially ninety degrees with respect to the door, so as fit in a square corner and result in a dishwasher assembly having a substantially triangular cross-section for enclosing the at least one rack and washer system.

17. The dishwasher assembly of claim 1 wherein the first and second wall-facing sides are formed at a predetermined angle of substantially zero degrees, so as to substantially define a single flat surface and thereby fit against a flat wall.

18. The dishwasher assembly of claim 17 wherein the door is formed substantially parallel to the first and second wall-facing sides, so as result in a dishwasher assembly having a substantially rectangular cross-section for enclosing the at least one rack and washer system.

19. The dishwasher assembly of claim 1 wherein the door comprises at least one tambour sliding door.

20. A dishwasher assembly comprising:
at least one rotary rack for retaining at least one dishware item to be washed, further comprising a rotation assembly for rotating the at least one rotary rack, so as to enable the insertion and removal of the at least one dishware item;
a washer system for respectively washing and drying the dishware item;
a dishwasher housing for retaining the at least one rack and the washer system, wherein the dishwasher housing comprises a door for accessing the at least one rotary rack, for inserting and removing the at least one dishware item.

21. The dishwasher assembly of claim 20 wherein the at least one rotary rack comprises a divider section for dividing the rotary rack into first and second sections, wherein the rotation assembly is configured for rotating the rotary rack so as to alternately present a respective one of the first and second sections to a first position, disposed proximate to the washer system, and a respective other of the first and second sections to a second position, disposed proximate to the door for inserting and removing the at least one dishware item.

22. The dishwasher assembly of claim 20 wherein the at least one rotary rack comprises a plurality of multi-tiered rotary racks.

23. The dishwasher assembly of claim 20 wherein the washer system comprises a spray arm for spraying water and a heating arrangement for drying the at least one dishware item.

24. The dishwasher assembly of claim 23 wherein the spray arm is a linear spray arm having a linear axis and configured for spraying with an oscillating motion about the linear axis.

25. The dishwasher assembly of claim 23 wherein the spray arm is a rotating spray arm.

26. The dishwasher assembly of claim 23 wherein the heating arrangement comprises a flash dryer system.

27. The dishwasher assembly of claim 20 wherein the washer system comprises a peristaltic pump for pumping water onto the at least one dishware item.

28. The dishwasher assembly of claim 20 wherein the washer system comprises a detergent dispenser for retaining a cleaning agent.

29. The dishwasher assembly of claim 28 wherein the detergent dispenser is a bulk detergent dispenser for retaining and dispensing a plurality of wash cycles of cleaning agent.

30. The dishwasher assembly of claim 29 wherein the detergent dispenser is configured to receive a container of detergent on a fitting, wherein detergent flows from the container into the fitting under the force of gravity, and into a collection cup, which is emptied by a motor that displaces the collection cup from a “fill” position to an “empty” position where the detergent flows into the dishwasher assembly under the force of gravity.

31. The dishwasher assembly of claim 30 wherein the motor is a wax motor.

32. The dishwasher assembly of claim 20 wherein the dishwasher assembly is a corner-mounted housing comprising a first wall-facing side and a second wall-facing side, wherein the first and second wall-facing sides are respectively formed at a predetermined angle.

33. The dishwasher assembly of claim 32 wherein the door is formed so as to extend between the first and second wall-facing sides, and wherein the first and second wall-facing sides are formed at a predetermined angle of less than ninety degrees with respect to the door.

34. The dishwasher assembly of claim 33 wherein the first and second wall-facing sides are formed at a predetermined angle of substantially ninety degrees with respect to the door, so as fit in a square corner and result in a dishwasher assembly having a substantially triangular cross-section for enclosing the at least one rack and washer system.

35. The dishwasher assembly of claim 32 wherein the first and second wall-facing sides are formed at a predetermined angle of substantially zero degrees, so as to substantially define a single flat surface and thereby fit against a flat wall.

36. The dishwasher assembly of claim 35 wherein the door is formed substantially parallel to the first and second wall-facing sides, so as result in a dishwasher assembly having a substantially rectangular cross-section for enclosing the at least one rack and washer system.

37. The dishwasher assembly of claim 20 wherein the door comprises at least one tambour sliding door.
